(19) United States
(12) Patent Application Publication
(10) Pub. No.: US 2023/0085076 A1
(43) Pub. Date: Mar. 16, 2023

(54) CONNECTOR CONVENIENT FOR DISASSEMBLING WATER PIPE

(71) Applicant: DONGGUAN HONGYU PLASTIC RUBBER CO.,LTD., Dongguan (CN)

(72) Inventor: Juying SHI, Nanchong (CN)

(73) Assignee: DONGGUAN HONGYU PLASTIC RUBBER CO.,LTD., Dongguan (CN)

(21) Appl. No.: 17/647,851

(22) Filed: Jan. 13, 2022

(30) Foreign Application Priority Data
Sep. 15, 2021 (CN) 202122235495.4

(51) Int. Cl. F16L 37/244

(52) U.S. Cl. CPC F16L 37/244

(57) ABSTRACT

A connector convenient for disassembling a water pipe includes a connecting joint and a connecting water pipe. The top end of the connecting joint is communicated with a first threaded cylinder, and the bottom of the connecting joint is fixedly connected to an annular fixing plate. The bottom of the annular fixing plate is fixedly connected to a fixing cylinder, and the surface of the fixing cylinder is fixedly connected to a fixing block. The inner wall of the connecting water pipe is provided with an L-shaped groove. In the installation of the connecting water pipe by setting the L-shaped groove, the annular clamping plate, the internal thread, the external thread and the movable cylinder, the fixing block is movably connected to the interior of the L-shaped groove, and then the fixing block is clamped inside the groove by rotating the connecting joint.

### CROSS REFERENCE TO THE RELATED APPLICATIONS

This application is based upon and claims priority to Chinese Patent Application No. 202122235495.4, filed on Sep. 15, 2021, the entire contents of which are incorporated herein by reference.

### TECHNICAL FIELD

The present invention relates to the technical field of a connector for a water pipe, and more particularly, to a connector convenient for disassembling a water pipe.

### BACKGROUND

The connectors, such as self-fixing water pipe connectors and external-thread end-connected water pipe connectors, are made of zinc alloy material and formed by die-casting with a surface that is galvanized, sanded, or chrome plated. Moreover, the connectors have characteristics of compact structure, no air hole, and high strength, so that the clamped-type water pipe connectors can connect an unthreaded steel pipe to a hose by simply screwing screws without a threading process, which exemplifies the compact structure and the high strength. Although the progress of science and technology today has promoted the technical progress of the connectors for the water pipe, there are still some shortcomings. Specifically, the prior connectors for the water pipe are inconvenient for the disassembly and installation process of the water pipe, generally, which usually rely upon the assistance of tools in the disassembly process, and have a poor seal.

### SUMMARY

In order to solve the problems raised in the above background technology. The present invention provides a connector convenient for disassembling a water pipe, which solves the technical problems of the inconvenient disassembly and installation of a water pipe as well as poor seal.

In order to achieve the above objectives, the technical solution provided by the present invention is as follows. A connector convenient for disassembling a water pipe includes a connecting joint and a connecting water pipe. The top end of the connecting joint is communicated with a first threaded cylinder, and the bottom of the connecting joint is fixedly connected to an annular fixing plate. The bottom of the annular fixing plate is fixedly connected to a fixing cylinder, and the surface of the fixing cylinder is fixedly connected to a fixing block. The inner wall of the connecting water pipe is provided with an L-shaped groove, and the fixing block is clamped inside the L-shaped groove. The surface of the connecting water pipe is fixedly connected to an annular clamping plate, and a movable cylinder is movably sleeved on the surface of the connecting water pipe. The interior of the movable cylinder is provided with an internal thread, the surface of the annular fixing plate is provided with an external thread, and the movable cylinder is threadedly connected to the annular fixing plate through the internal thread and the external thread. One end of the connecting water pipe is communicated with a swimming pool, and a valve is arranged on the connecting water pipe.

As a further solution of the present invention: two L-shaped grooves and two fixing blocks are arranged, and the two fixing blocks are clamped inside the two L-shaped grooves, respectively.

As a further solution of the present invention: the bottom of the inner wall of the L-shaped groove is provided with an elastic rubber pad, and the top of the elastic rubber pad is lapped with the fixing block.

As a further solution of the present invention: a sealing pad is arranged between the movable cylinder and the annular clamping plate.

As a further solution of the present invention: the surface of the movable cylinder is fixedly connected to a first buckle plate.

As a further solution of the present invention: the surface of the connecting joint is fixedly connected to a second buckle plate.

Compared with the prior art, the advantages of the present invention are as follows.

1. For the connector convenient for disassembling the water pipe, in the installation of the connecting water pipe by setting the L-shaped groove, the annular clamping plate, the internal thread, the external thread and the movable cylinder, the fixing block is movably connected to the interior of the L-shaped groove, and then the fixing block is clamped inside the groove by rotating the connecting joint, so that the connecting water pipe is communicated with the connecting cylinder. The connecting water pipe and the connecting joint are fixed with each other through the threaded connection between the movable cylinder and the annular clamping plate, which is convenient for the installation and disassembly of the connecting water pipe.

2. For the connector convenient for disassembling the water pipe, the sealing pad, the first buckle plate and the second buckle plate are set. In this way, the seal between the connecting water pipe and the connecting joint is improved through the sealing pad; it is convenient to rotate and adjust the movable cylinder through the first buckle plate; and it is convenient to rotate and adjust the connecting joint through the second buckle plate.

### BRIEF DESCRIPTION OF THE DRAWINGS

The drawings are used to provide further understanding of the present invention, form part of the specification, and are used to explain the present invention together with the embodiment of the present invention, which does not constitute limitations to the present invention. In the drawings:

FIG. 1 is a structural schematic diagram showing a front view of a cross section of the present invention.

FIG. 2 is a schematic diagram showing a connection structure of a cross section of a connecting water pipe in the present invention.

FIG. 3 is an enlarged view of the structure of part A circled in FIG. 2 of the present invention.

FIG. 4 is an enlarged view of the structure of part B circled in FIG. 2 of the present invention.

In Figures.: 1—connecting joint; 2—first threaded cylinder; 3—annular fixing plate; 4—fixing cylinder; 5—fixing block; 6—connecting water pipe; 7—L-shaped groove; 8—elastic rubber pad; 9—annular clamping plate; 10—sealing pad; 11—movable cylinder; 12—internal thread; 13—external thread; 14—first buckle plate; 15—second buckle plate; 16—swimming pool; 17—valve.

### DETAILED DESCRIPTION OF THE EMBODIMENTS

The technical solution in an embodiment of the present invention is clearly and completely described below with reference to the drawings in the embodiment of the present invention. Obviously, the described embodiment is only a part, not all, of the embodiments of the present invention. Based on the embodiments of the present invention, all other embodiments obtained by those skilled in the art without creative effort shall fall within the scope of protection of the present invention.

### Embodiment

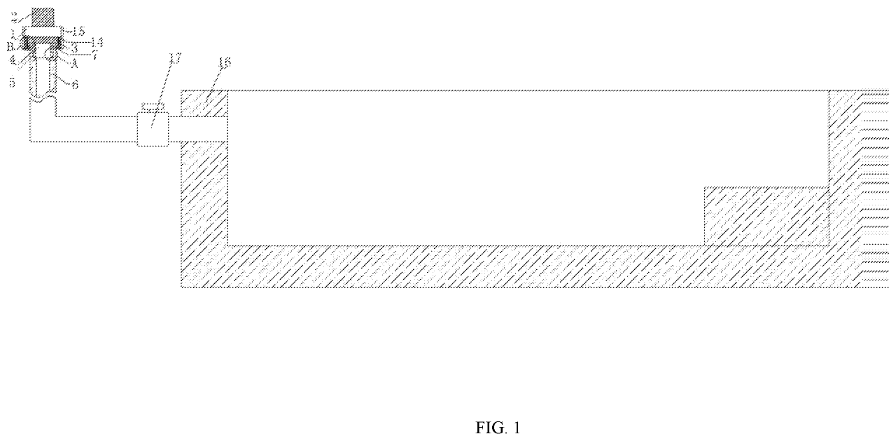

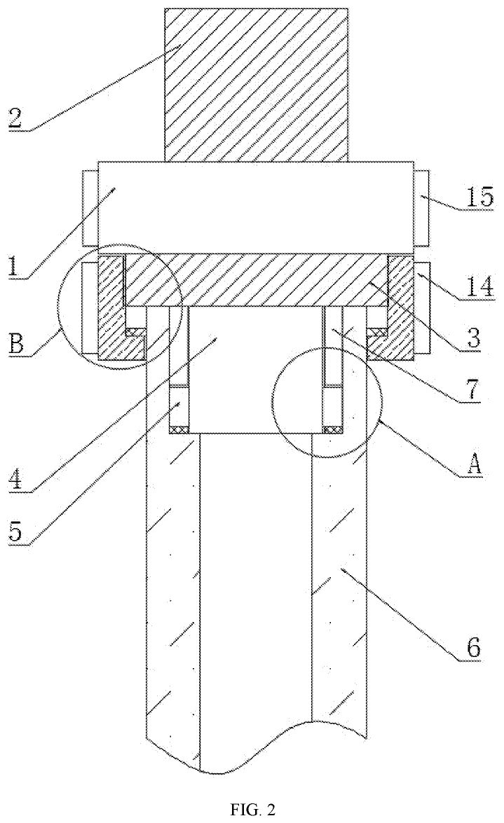

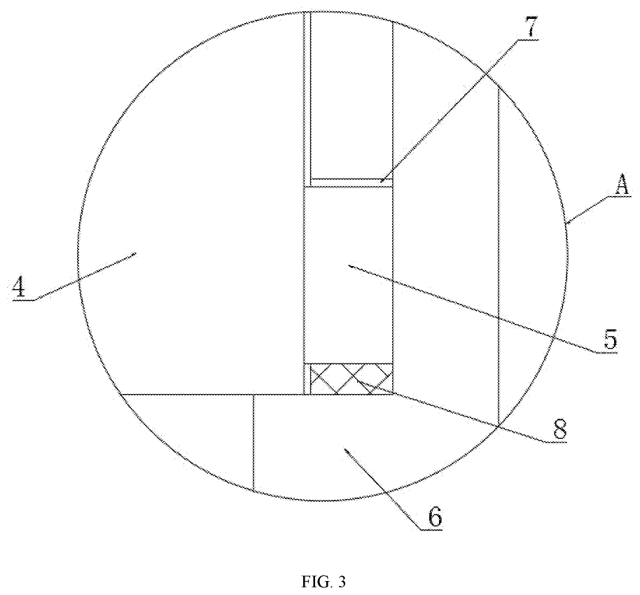

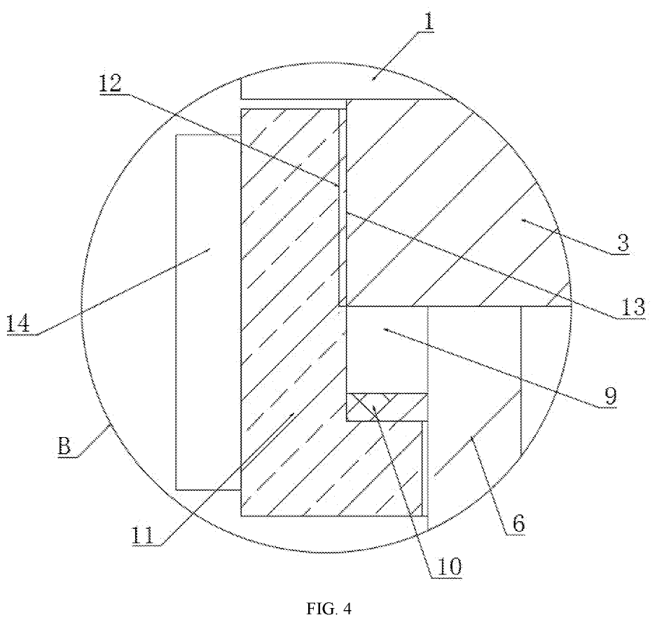

Referring to FIGS. 1 to 4, the present invention provides the following technical solution. A connector convenient for disassembling a water pipe includes the connecting joint 1 and the connecting water pipe 6. The top end of the connecting joint 1 is communicated with the first threaded cylinder 2, and the bottom of the connecting joint 1 is fixedly connected to the annular fixing plate 3. The bottom of the annular fixing plate 3 is fixedly connected to the fixing cylinder 4, and the surface of the fixing cylinder 4 is fixedly connected to the fixing block 5. The inner wall of the connecting water pipe 6 is provided with the L-shaped groove 7, and the fixing block 5 is clamped inside the L-shaped groove 7. The surface of the connecting water pipe 6 is fixedly connected to the annular clamping plate 9, and the movable cylinder 11 is movably sleeved on the surface of the connecting water pipe 6. The interior of the movable cylinder 11 is provided with the internal thread 12, the surface of the annular fixing plate 3 is provided with the external thread 13, and the movable cylinder 11 is threadedly connected to the annular fixing plate 3 through the internal thread 12 and the external thread 13. One end of the connecting water pipe 6 is communicated with the swimming pool 16, and the valve 17 is arranged on the connecting water pipe 6. In the installation of the connecting water pipe 6 by setting the L-shaped groove 7, the annular clamping plate 9, the internal thread 12, the external thread 13 and the movable cylinder 11, the fixing block 5 is movably connected to the interior of the L-shaped groove 7, and then the fixing block 5 is clamped inside the groove by rotating the connecting joint 1, so that the connecting water pipe 6 is communicated with the connecting cylinder. The connecting water pipe 6 and the connecting joint 1 are fixed with each other through the threaded connection between the movable cylinder 11 and the annular clamping plate 9, which is convenient for the installation and disassembly of the connecting water pipe 6.

Specifically, two L-shaped grooves 7 and two fixing blocks 5 are arranged, and the two fixing blocks 5 are clamped inside the two L-shaped grooves 7, respectively. The bottom of the inner wall of the L-shaped groove 7 is provided with the elastic rubber pad 8, and the top of the elastic rubber pad 8 is lapped with the fixing block 5, so that the connecting water pipe 6 is connected to the fixing cylinder 4 more stably through the elastic rubber pad 8.

Specifically, the sealing pad 10 is arranged between the movable cylinder 11 and the annular clamping plate 9, so that the seal between the connecting water pipe 6 and the connecting joint 1 is improved through the sealing pad 10. The surface of the movable cylinder 11 is fixedly connected to the first buckle plate 14, which is convenient to rotate and adjust the movable cylinder 11 through the first buckle plate 14. The surface of the connecting joint 1 is fixedly connected to the second buckle plate 15, which is convenient to rotate and adjust the connecting joint 1 through the second buckle plate 15.

The working principle of the present invention is as follows:

In use, when it is required to disassemble and replace the connecting water pipe 6, the movable cylinder 11 is separated from the annular clamping plate 9 by rotating the movable cylinder 11 through the first buckle plate 14. Then, the fixing block 5 is moved in the interior of the L-shaped groove 7 by rotating the connecting water pipe 6, and the fixing block 5 is separated from the L-shaped groove 7 by pulling the connecting water pipe 6, so as to disassembly the connecting water pipe 6 and install another connecting water pipe 6.

Although the embodiment of the present invention has been shown and described above, it can be understood that the above embodiment is exemplary and cannot be understood as limitations on the present invention. Those having skilled in the art may change, revise, replace and modify the above embodiment within the scope of the present invention.

What is claimed is:

1. A connector convenient for disassembling a water pipe, comprising a connecting joint and a connecting water pipe, wherein
a top end of the connecting joint is communicated with a first threaded cylinder, and a bottom of the connecting joint is fixedly connected to an annular fixing plate;
a bottom of the annular fixing plate is fixedly connected to a fixing cylinder, and a surface of the fixing cylinder is fixedly connected to fixing blocks;
an inner wall of the connecting water pipe is provided with L-shaped grooves, and the fixing blocks are clamped inside the L-shaped grooves;
a surface of the connecting water pipe is fixedly connected to an annular clamping plate, and a movable cylinder is movably sleeved on the surface of the connecting water pipe;
an interior of the movable cylinder is provided with an internal thread, a surface of the annular fixing plate is provided with an external thread, and the movable cylinder is threadedly connected to the annular fixing plate through the internal thread and the external thread; and
one end of the connecting water pipe is communicated with a swimming pool, and a valve is arranged on the connecting water pipe.

2. The connector according to claim 1, wherein two L-shaped grooves and two fixing blocks are arranged, and the two fixing blocks are clamped inside the two L-shaped grooves, respectively.

3. The connector according to claim 1, wherein a bottom of an inner wall of each of the L-shaped grooves is provided with an elastic rubber pad, and a top of the elastic rubber pad is lapped with one of the fixing blocks.

4. The connector according to claim 1, wherein a sealing pad is arranged between the movable cylinder and the annular clamping plate.

5. The connector according to claim 1, wherein a surface of the movable cylinder is fixedly connected to a first buckle plate.

6. The connector according to claim 1, wherein a surface of the connecting joint is fixedly connected to a second buckle plate.
